(19) United States
(12) Patent Application Publication
(10) Pub. No.: US 2022/0114444 A1
(43) Pub. Date: Apr. 14, 2022

(54) SUPERLOSS: A GENERIC LOSS FOR ROBUST CURRICULUM LEARNING

(71) Applicant: NAVER CORPORATION, Gyeonggi-do (KR)

(72) Inventors: Philippe WEINZAEPFEL, Montbonnot-Saint-Martin (FR); Jérome REVAUD, Meylan (FR); Thibault CASTELLS, La Buisse (FR)

(73) Assignee: NAVER CORPORATION, Gyeonggi-do (KR)

(21) Appl. No.: 17/383,860

(22) Filed: Jul. 23, 2021

(30) Foreign Application Priority Data
Oct. 9, 2020 (EP) 20306187.4

(51) Int. Cl. G06N 3/08; G06N 3/04

(52) U.S. Cl. CPC G06N 3/08; G06N 3/04

(57) ABSTRACT

A computer-implemented method for training a neural network to perform a data processing task includes: for each data sample of a set of labeled data samples: by a first loss function for the data processing task, computing a first loss for that data sample; and by a second loss function, automatically computing a weight value for the data sample based on the first loss, the weight value indicative of a reliability of a label of the data sample predicted by the neural network for the data sample and dictating the extent to which that data sample impacts training of the neural network; and training the neural network with the set of labelled data samples according to their respective weight value.

### CROSS-REFERENCE TO RELATED APPLICATIONS

This application claims the benefit of European Application No. 20306187.4, filed on Oct. 9, 2020. The entire disclosure of the application referenced above is incorporated herein by reference.

### FIELD

The present disclosure relates to a loss function for training neural networks using curriculum learning. In particular, the present disclosure relates to a method for training a neural network to perform a task, such as an image processing task, using a task-agnostic loss function that is appended on top of the loss associated with the task.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Curriculum learning is a technique inspired by the learning process of humans and animals. Curriculum learning involves feeding training samples to the learner (a neural network) in order of increasing difficulty, just like humans naturally learn easier concepts before more complex ones. When applied to machine learning, curriculum learning involves designing a sampling strategy (a curriculum) that would present easy samples to the neural network (model) before harder ones.

Generally speaking, easy samples are samples for which the neural network makes a good (accurate) prediction after a small number of training steps. By way of contrast, hard samples are samples for which the neural network may make makes a bad (inaccurate) prediction after a small number of training steps. More training stems may be performed to train the neural network to make good predictions for hard samples.

While it is generally complex to estimate a priori the difficulty of a given sample, curriculum learning can be formulated dynamically in a self-supervised manner. This may involve estimating the importance (or weight) of each sample directly during training based on the observation that easy and hard samples behave differently and can therefore be separated.

Curriculum learning may be effective at improving the model performance and its generalization power. However, determining the order prior to the training may lead to potential inconsistencies between the fixed curriculum and the model being learned.

To remedy this, self-paced learning may be used where the curriculum is constructed without supervision in a dynamic way to adjust to the pace of the learner. This may be possible because easy and hard samples may behave differently during training in terms of their respective loss, allowing them to be somehow discriminated. In this context, curriculum learning is accomplished by predicting the easiness of each sample at each training iteration in the form of a weight, such that easy samples receive larger weights during the early stages of training and vice versa. A benefit of this type of approach, aside from improving the model generalization, is an improvement in resistance to noise. This is due to the fact that noisy samples (i.e., samples with wrong labels/annotations) tend to be harder for the model and thus receive smaller weights throughout training, effectively discarding noisy samples. This side effect makes these methods especially attractive when clean (non-noisy) annotated data is expensive and limited and while noisy data is widely available and cheap.

Automatic curriculum learning may suffer from two drawbacks that may limit their applicability. First, automatic curriculum learning may overwhelmingly focus and specialize on the classification task, even though the principles mentioned above are general and can potentially apply to other tasks. Second, automatic curriculum learning may require important changes in the training procedure, often requiring dedicated training schemes, involving multi-stage training with or without special warm-up periods, extra learnable parameters and layers, or a clean subset of data.

A type of loss functions, referred to herein as confidence-aware loss-functions, may be used for various different types of tasks and backgrounds. Consider a dataset {(xⁱ, yⁱ)}_{i=1′}^{N} where sample xⁱ has label yⁱ, and let ƒ(⋅) be a trainable predictor to optimize in the context of empirical risk minimization. Compared to traditional loss functions of the form loss [symbol] (ƒ(xⁱ), yⁱ), confidence-aware loss functions take an additional learnable parameter as input which represents the sample confidence σⁱ≥0. Confidence-aware loss functions can therefore be written as [symbol] (ƒ(xⁱ), yⁱ, σⁱ).

The confidence-learning property may depends on the shape of the confidence-aware loss function, which can be summarized as two properties: (a) a correctly predicted sample is encouraged to have a high confidence and an incorrectly predicted sample is encouraged to have a low confidence, and (b) at low confidences, the loss is almost constant. In other words, a confidence-aware loss function modulates the loss of each sample with respect to its confidence parameter. These properties may be interesting in the context of dynamic curriculum learning as they allow to learn the confidence, i.e., weight, of each sample automatically through back-propagation and without further modification of the learning procedure.

Jointly minimizing the network parameters and the confidence parameters via standard stochastic gradient descent may lead to accurately estimating the reliability of each prediction, i.e. the difficulty of each sample, via the confidence parameter. The modified cross-entropy loss introduces for classification may produce a tempered version of the cross-entropy loss where a sample-dependent temperature scales logits before computing the softmax:

$${ℓ}_{DataParams} ( z , y , σ ) = - log ( \frac{exp ( σ {z}_{y} )}{{Σ}_{j} exp ( σ {z}_{j} )} )$$

where z∈ [symbol] ^{C} are the logits for a given sample (C is the number of classes), y∈{1, . . . , C} its ground-truth class and σ>0 its confidence (i.e., inverse of the temperature). Interestingly, this loss transforms into a robust 0-1 loss (i.e., step function) when the confidence trends to infinity:

$${lim}_{σ \to + ∞} {ℓ}_{DataParams} ( z , y , σ ) = \{ \begin{matrix} 0 , & if {z}_{y} > {max}_{j} z \\ + ∞ , & otherwise \end{matrix}$$

A regularization term equal to λ log(σ)² may be added to the loss to prevent a from inflating. While the modified cross-entropy loss handles the case of classification well, similarly to confidence-aware losses, it hardly generalizes to other tasks.

Another confidence-aware loss function is introspection loss, which may be used in the context of keypoint matching between different class instances. It can be rewritten from the original formulation in a more compact form as:

$${ℓ}_{introspection} ( s , y , σ ) = log ( \frac{exp ( σ ) - 1}{σ} ) - σ ys$$

where s∈{−1,1} is a similarity score between two keypoints computed as a dot-product between their representation, y∈{−1,1} is the ground-truth label for the pair, and σ>0 is an input dependent prediction of the reliability of the two keypoints. This loss may hardly generalize to other tasks as it may have been specially designed to handle similarity scores in the range [0,1] with binary labels.

Reliability loss may be used in the context of robust patch detection and description. The reliability loss may serve to jointly learn a patch representation along with its reliability (i.e., a confidence score for the quality of the representation), which is also an input dependent output of the network. It may be formulated as:

$${ℓ}_{R 2 D 2} ( z , y , σ ) = σ ( 1 - AP ( z \cdot y ) ) + \frac{1 - σ}{2}$$

where z represents a patch descriptor, y its label, and σ∈[0,1] its reliability. The score for the patch may be computed in the loss in term of differentiable Average-Precision (AP).

The reliability a may not be an unconstrained variable (e.g., it may be bounded between 0 and 1), making it difficult to regress. Second, due to the lack of regularization, the optimal reliability may be either 0 or 1, depending on whether AP(z,y)<0.5 or not. In other words, for a given fixed AP(z,y)<0.5, the loss is minimized by setting σ=0 and vice versa, which may encourage the reliability to take extreme values.

Multi-task loss may involve automatically learning the relative weight of each loss in a multi-task context. The intuition is to model the network prediction as a probabilistic function that depends on the network output and an uncontrolled homoscedastic uncertainty. Then, the log likelihood of the model is maximized as in maximum likelihood inference. This leads to the following minimization objective, defined according to several task losses { [symbol] ₁, . . . , [symbol] ₙ} with their associated uncertainties {σ₁, . . . , σₙ} (i.e. inverse confidences):

$${ℓ}_{multitask} ( {ℓ}_{1} , … , {ℓ}_{n} , {σ}_{1} , … , {σ}_{n} ) = {\sum }_{i = 1}^{n} \frac{{ℓ}_{i}}{2 {σ}_{i}^{2}} + log {σ}_{i}$$

In practice, the confidence is learned via an exponential mapping s=log σ² to ensure that σ>0. This approach may make the implicit assumption that task losses are positive with a minimum min [symbol] ᵢ=0∀i, which may not be guaranteed in general. In the case where one of the task loss would be negative, nothing would indeed prevent the multi-task loss to inflate to −∞.

Learning on noisy data may be inherently difficult. In this context, curriculum learning may be appropriate as it automatically downweights samples based on their difficulty, effectively discarding noisy samples. For example, samples may be adaptively selected for model training and noisy samples that have a larger loss can be avoided. For example, non-noisy samples can be distinguished from noisy samples by monitoring their loss while varying the learning rate. As another example, model the per-sample loss distribution with a bi-modal mixture model may be used to dynamically divide the training data into clean and noisy sets. Ensembling methods may prevent the memorization of noisy samples. For instance, progressive filtering of samples from easy to hard ones at each epoch can be used, which can be viewed as curriculum learning. Co-teaching and similar methods may train two semi-independent networks that exchange information about noisy samples to avoid their memorization. However, these approaches may be developed specifically for a given task (e.g., classification) and hardly generalize to other tasks. Furthermore, these approaches may require a dedicated training procedure which can be cumbersome.

Accordingly, approaches may be limited to a specific task (e.g., classification) and require extra data annotations, layers, or parameters as well as a dedicated training procedure.

### SUMMARY

Described herein is a simple and generic method that can be applied to a variety of losses and tasks without any change in the learning procedure. It includes in appending a generic loss function on top of an existing task loss, hence its name: SuperLoss. One effect of SuperLoss is to automatically downweight the contribution of samples with a large loss (i.e. hard samples), effectively mimicking curriculum learning. SuperLoss prevents the memorization of noisy samples, making it possible to train from noisy data even with non-robust loss functions.

SuperLoss allows training models that will perform better, especially in the case where training data includes noisy samples. This is advantageous given the enormous annotation efforts necessary to build very large-scale training datasets. Having to annotate a large-scale training dataset might be a barrier for entering new businesses, because of both the financial aspects and the time it would take. In contrast, noisy datasets can be automatically collected from the web at a large scale for a relatively small cost.

In a feature, a computer-implemented method for training a neural network to perform a data processing task is provided. The method includes, for each data sample of a set of labeled data samples: computing a task loss for the data sample using a first loss function for the data processing task; computing a second loss for the data sample by inputting the task loss into a second loss function, the second loss function automatically computing a weight of the data sample based on the task loss computed for the data sample to estimate reliability of a label of the data sample predicted by the neural network; and updating at least some learnable parameters of the neural network using the second loss. The data samples may be one of image samples, video samples, text content samples and audio samples.

Because the weight of the data sample is automatically determined for the data sample based on the task loss of the data sample, the method provides an advantage that there is no need to wait for a confidence parameter to converge, meaning that the training method converges more rapidly.

In further features, automatically computing a weight of the data sample based on the task loss computed for the data sample may include increasing the weight of the data sample if the task loss is below a threshold value and decreasing the weight of the data sample if the task loss is above the threshold value.

In further features, the threshold value may be computed using a running average of the task loss or an exponential running average of the task loss with a fixed smoothing parameter.

In further features, the second loss function may include a loss-amplifying term based on a difference between the task loss and the threshold value.

In further features, the second loss function is given by min{l−τ, λ(l−τ)} with 0<λ<1, where l is the task loss, τ is the threshold value and λ is a hyperparameter of the second loss function.

In further features, the method may further include computing a confidence value of the data sample based on the task loss. Computing the confidence value of the data sample based on the task loss may include determining a value of a confidence parameter that minimizes the second loss function for the task loss. The confidence value may depend on

$$\frac{( ℓ - τ )}{λ} ,$$

where [symbol] is the task loss, τ is the threshold value and λ is a regularization hyperparameter of the second loss function. The loss-amplifying term may be given by σ*( [symbol] −τ), where σ* is the confidence value.

Thus, because the confidence value is determined for each respective data sample using an efficient closed-form solution, the method is much simpler and more efficient.

In further features, the second loss function may include a regularization term that given by λ(log σ*)², where σ* is the confidence value.

In further features, the second loss function may be given by

$${min}_{σ} ( σ ( ℓ - τ ) + {λ ( log σ )}^{2} ) ,$$

where σ is the confidence parameter, [symbol] is the task loss, τ is the threshold value and λ is a hyperparameter of the second loss function.

In further features, the second loss function may be a monotonically increasing concave function with respect to the task loss.

In further features, the second loss function may be a homogeneous function.

In further features, a neural network trained using the method above to perform a data processing task is provided. The data processing task may be an image processing task. The image processing task may be one of classification, regression, object detection and image retrieval.

In further features, a computer-readable storage medium includes computer-executable instructions stored thereon, which, when executed by one or more processors perform the method above.

In further features, an apparatus includes processing circuitry, the processing circuitry being configured to perform the method above.

In a feature, a computer-implemented method for training a neural network to perform a data processing task includes: for each data sample of a set of labeled data samples: by a first loss function for the data processing task, computing a first loss for that data sample; and by a second loss function, automatically computing a weight value for the data sample based on the first loss, the weight value indicative of a reliability of a label of the data sample predicted by the neural network for the data sample and dictating the extent to which that data sample impacts training of the neural network; and training the neural network with the set of labelled data samples according to their respective weight value.

In further features, automatically computing the weight value for the data sample includes increasing the weight value for the data sample if the first loss is less than a threshold value.

In further features, automatically computing the weight value for the data sample includes decreasing the weight value for the data sample if the first loss is greater than the threshold value.

In further features, the method further includes computing the threshold value based on a running average of the first loss.

In further features, the method further includes computing the threshold value based on an exponential running average of the first loss and using a smoothing parameter.

In further features, the threshold value is a fixed predetermined value.

In further features, automatically computing the weight value includes, by the second loss function, automatically computing the weight value further based on a regularization hyperparameter and a threshold value.

In further features, automatically computing the weight value includes, by the second loss function, setting the weight value one of (a) based on and (b) equal to, a minimum one of: [symbol] −τ; and λ( [symbol] −τ), where [symbol] is the first loss, τ is the threshold value, and λ is the regularization hyperparameter that is between 0 and 1.

In further features, automatically computing the weight value includes, by the second loss function, automatically computing the weight value further based on a confidence value of the data sample.

In further features, the method further includes computing the confidence value of the data sample based on the first loss.

In further features, computing the confidence value of the data sample includes computing the confidence value based on minimizing the second loss function for the first loss.

In further features, computing the confidence value of the data sample includes computing the confidence value based on

$$\frac{( ℓ - τ )}{λ} ,$$

where [symbol] is the first loss, τ is the threshold value, and λ is the regularization hyperparameter.

In further features, automatically computing the weight value includes, by the second loss function, automatically computing the weight value based on a loss amplifying term given by σ*( [symbol] −τ), where σ* is the confidence value, [symbol] is the first loss, and τ is the threshold value.

In further features, automatically computing the weight value includes, by the second loss function, automatically computing the weight value based on a regularization term given by λ(log σ*)², where σ* is the confidence value, λ is the regularization hyperparameter, and log represents the logarithm function.

In further features, automatically computing the weight value includes, by the second loss function, automatically computing the weight value using the equation

$${min}_{σ} ( σ ( ℓ - τ ) + {λ ( log σ )}^{2} ) ,$$

where σ is the confidence value, [symbol] is the first loss, τ is the threshold value, λ is the regularization hyperparameter, and log represents the logarithm function.

In further features, the second loss function is a monotonically increasing concave function.

In further features, the second loss function is a homogeneous function.

In further features, a neural network is described as trained according to the method.

In a feature, a training system includes: one or more processors; memory including instructions that, when executed by the one or more processors, train a neural network to perform a data processing task by, for each data sample of a set of labeled data samples: using a first loss function for the data processing task, computing a first loss for that data sample; using a second loss function, automatically computing a weight value for the data sample based on the first loss, the weight value indicative of a reliability of a label of the data sample predicted by the neural network for the data sample; and selectively updating a trainable parameter of the neural network based on the weight value.

In a feature, a training method for training a neural network to perform a data processing task includes: for each data sample of a set of labeled data samples: by a first loss function for the data processing task, computing a first loss for that data sample; and by a second loss function, automatically computing a weight value for the data sample based on the first loss, the weight value indicative of a reliability of a label of the data sample predicted by the neural network for the data sample and dictating the extent to which that data sample impacts training of the neural network; and training the neural network using the set of labelled data samples with impacts defined by their respective weight values.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram illustrating a neural network being trained using the techniques described herein;

FIGS. 2A and 2B are plots showing losses produced by an easy sample and a hard sample during training;

FIG. 3 is a plot showing SuperLoss as a function of a normalized input loss;

FIG. 4 is a flow diagram of a method of training a neural network using the SuperLoss function;

FIG. 5 is a plot showing the mean absolute error for the regression task on digit regression on the MNIST dataset and on human age regression on the UTKFace dataset;

FIG. 6 is a plot showing the evolution of the normalized confidence value during training;

FIG. 7 is a plot showing the accuracy of the loss function on CIFAR-10 and CIFAR-100 datasets as a function of the proportion of noise;

FIG. 8 is a plot showing the impact of the regularization parameter for different proportions of noise;

FIGS. 9A-9B are plots showing AP50 on Pascal VOC when using the SuperLoss for object detection with Faster R-CNN and RetinaNet, respectively;

FIG. 10 is a plot showing model convergence during training on the noisy Landmarks-full dataset; and

FIG. 11 illustrates an example of architecture in which the disclosed methods may be performed.

In the drawings, reference numbers may be reused to identify similar and/or identical elements.

### DETAILED DESCRIPTION

There is a need for a generalized and simplified loss function that overcomes the disadvantages discussed above. In particular, there is a need to provide a loss function to estimate reliability of data sample labels predicted by a neural network (module), where the loss function can be applied to any loss and thus to any task, can scale-up to any number of samples, requires no modification of the learning procedure, and has no need for extra data parameters.

Described herein are systems and methods for training neural networks using curriculum learning. Specifically, the SuperLoss function—a generalized loss function that can be applied to any task—is described. For purposes of explanation, numerous examples and specific details are set forth in order to provide a thorough understanding of the described embodiments. Embodiments as defined by the claims may include some or all of the features in these examples alone or in combination with other features described below, and may further include modifications and equivalents of the features and concepts described herein. The illustrative embodiments will be described with reference to the drawings wherein like elements and structures are indicated by like reference numbers. Further, where an embodiment is a method, steps and elements of the method may be combinable in parallel or sequential execution. As far as they are not contradictory, all embodiments described below can be combined with each other.

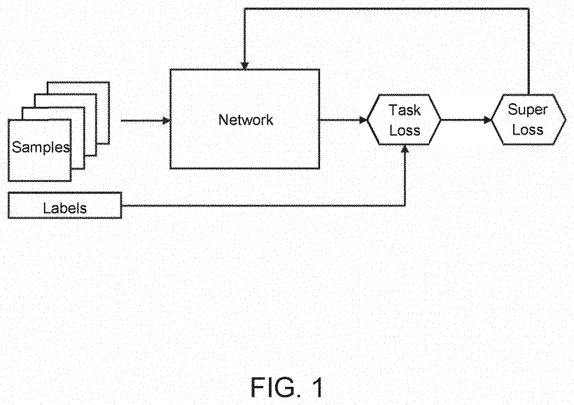

FIG. 1 is a block diagram illustrating supervised training of a neural network using SuperLoss. The neural network is configured to receive as input a set of labeled data samples {(xⁱ, yⁱ)}_{i=1′}^{N} where sample xⁱ has label yⁱ, is input into the neural network. The set of labeled data samples may be one of a set of labeled sample images, a set of labeled text documents, and a set of labeled audio content.

The neural network is configured to process each of the data samples to generate a prediction (e.g., a label) for the respective data sample. The loss function corresponding to the task that the neural network is being trained to perform (also referred to herein as a first loss function) indicates the error between the prediction output by the neural network based on a data sample and a target value for the data sample. For example, in supervised learning, the neural network generates a prediction for the label of the data sample. The predicted label for each data sample is then compared to the ground truth label of the data sample. The difference (the error) between the ground truth label and the predicted label is a task loss output by the neural network. In various implementations, the task loss function (module) may be executed separately from the neural network.

In neural networks, the task loss is used to update at least some of the learnable parameters of the neural network using backpropagation. However, as shown in FIG. 1, a second loss function (also referred to herein as the SuperLoss function or module) is appended to the task loss of the neural network.

SuperLoss function monitors the task loss of each data sample during training and automatically determines a sample contribution dynamically by applying curriculum learning. The SuperLoss function increases the weight of easy samples (those with a small task loss) and decreases the weight of hard samples (those with a high task loss). In other words, the SuperLoss function computes a weight of each data sample based on the task loss computed for the data sample to estimate reliability of a label of the data sample predicted by the neural network.

The SuperLoss function is task-agnostic, meaning that it can be applied to the task loss without any change in the training procedure. Accordingly, the neural network may be any type of neural network having a corresponding loss function suitable for processing the data samples. For example, the neural network may be trained to perform an image processing task, such as image classification, regression, object detection, image retrieval, or another suitable image processing task. The neural network may be suitable to perform tasks in other domains that rely on machine learning to train a model, such as natural language processing, content recommendation, or another suitable task.

The SuperLoss function is defined based on pragmatic and general considerations: the weight of samples with a small loss should be increased (thereby increasing such samples' impact on trainable parameters of a neural network) and the weight of samples with a high loss should be decreased (thereby decreasing such samples' impact on trainable parameters of a neural network).

The SuperLoss function may be a monotonically increasing concave function that amplifies the reward (i.e., negative loss) for easy samples (where the prediction loss is below a threshold value) while (e.g., strongly) flattening the loss for hard samples (where the prediction loss is greater than the threshold value). In other words, SL*( [symbol] ₂)≥SL*( [symbol] ₁) if [symbol] ₂≥ [symbol] ₁. The monotonically increasing property can be mathematically written as SL*( [symbol] ₂)≥SL*( [symbol] ₁) if [symbol] ₂≥ [symbol] ₁. The fact to emphasize samples with lower losses than the one with higher input losses can be express as SL*′( [symbol] ₂)≤SL*′( [symbol] ₁) if [symbol] ₂≥ [symbol] ₁, where SL*′ is the derivative.

Optionally, the SuperLoss function may be a homogenous function, meaning that it can handle an input loss of any given range and thus any kind of tasks. More specifically, the shape of the SuperLoss may stay exactly the same up to a constant scaling factor γ>0, when the input loss and the regularization parameter are both scaled by the same factor γ. In other words, scaling may be according to the regularization parameter and the learning rate to accommodate for an input loss of any given amplitude.

The SuperLoss function may take one input, the task loss of the neural network. This is in contrast to confidence-aware loss functions that take an additional learnable parameter representing the sample confidence as input. For each sample data item, the SuperLoss function computes a weight of the data sample according to the task loss for the data sample. The SuperLoss function outputs a loss (also referred to herein as the second loss and as the SuperLoss) that is used for backpropagation to update at least one or more learnable parameters of the neural network.

The SuperLoss includes a loss-amplifying term and a regularization term controlled by the hyper-parameter λ≥0 and is given by:

SL*( [symbol] )=min{ [symbol] −τ,λ( [symbol] −τ)} with 0<λ<1 (1)

where SL stands for SuperLoss, [symbol] is the task loss of the neural network, τ is a threshold value that separates easy samples from hard samples based on their respective loss, and λ is the regularization hyperparameter. The threshold value τ is either fixed based on prior knowledge of the task, or computed for each data sample. For example, the threshold value may be determined using a running average of the input loss or an exponential running average of the task loss with a fixed smoothing parameter.

In various implementations, the SuperLoss function takes into account a confidence value associated with a respective data sample. A confidence-aware loss function that takes two inputs, namely, the task loss [symbol] (ƒ(xⁱ),yⁱ) and a confidence parameter σⁱ, which represents the sample confidence, is given by:

SL( [symbol] ƒ(xⁱ),yⁱ,σⁱ))=σⁱ×( [symbol] (ƒ(xⁱ),yⁱ)−τ)+λ(log σⁱ)² (2)

However, in the SuperLoss function, in contrast to confidence-aware loss functions, the confidence parameter σⁱ is not learned, but is instead automatically deduced for each sample from the respective task loss of the sample. Accordingly, instead of waiting for the confidence parameters σⁱ to converge, SuperLoss function directly uses the converged value σ*( [symbol] )=argmin_{σ}SL( [symbol] , σ) that depends only on the task loss [symbol] . As a consequence, the confidence parameters σⁱ do not need to be optimized and up-to-date with the sample status, making SuperLoss depend solely on the task loss:

SL*( [symbol] )=SL( [symbol] ,σ*( [symbol] )) (3)

The optimal confidence σ*( [symbol] ) has a closed form solution that is computed by the SuperLoss function finding the confidence value σ*( [symbol] ) that minimizes SL( [symbol] , σ) for a given task loss [symbol] . As a corollary, it means that the SuperLoss function can handle a task loss of any range (or amplitude), i.e. λ just needs to be set appropriately.

Accordingly, for each training sample, the SuperLoss function is given by:

SL*_{λ}( [symbol] ,σ)=σ( [symbol] −τ)+λ(log σⁱ)² (4)

where the task loss [symbol] and the confidence a correspond to an individual training sample.

The SuperLoss function includes an exponential mapping σ=e^{c} to ensure that σ>0. Using the exponential mapping for confidence, the equation can be rewritten as:

$${SL}^{*} ( ℓ ) = {min}_{σ} σ ( ℓ - τ ) + {λ ( log σ )}^{2}$$

$${SL}^{*} ( ℓ ) = {min}_{x} {e}^{x} ( ℓ - τ ) + λ {x}^{2}$$

$${SL}^{*} ( ℓ ) = {min}_{x} β {e}^{x} + {x}^{2} , \\ where \\ λ > 0 , β = \frac{ℓ - τ}{λ} and σ = {e}^{x} .$$

The SuperLoss function to minimize admits a global minimum in the case where β≥0, as it is the sum of two convex functions. Otherwise, due to the negative exponential term it diverges towards −∞ when x→+∞. However, in the case where β₀<β<0 with

$${β}_{0} = \frac{2}{e} ,$$

the SuperLoss function admits a single local minimum located in x∈[0,1] (see below), which corresponds to the value the confidence would converge to assuming that it initially starts at σ=1 (x=0) and moves continuously by infinitesimal displacements. In the case where it exists (i.e., when β₀<β), the position of the minimum is given by solving the derivative:

$$\frac{\partial }{\partial x} ( β {e}^{x} + {x}^{2} ) = 0 \\ ⇔ β {e}^{x} + 2 x = 0 \\ ⇔ β {e}^{x} = - 2 x \\ ⇔ \frac{β}{2} = - x exp ( - x ) .$$

This is an equation of the form z=ye^{y} with {z,y}∈ [symbol] ², a problem having y=W(z) for a solution, where W stands for the Lambert W function. The closed form for x in the case where β₀<β is thus generally given by:

$$x = - W ( \frac{β}{2} ) \\ ⇔ log {σ}^{*} = - W ( \frac{β}{2} ) \\ ⇔ {σ}^{*} = {e}^{- W ( \frac{β}{2} )} \qquad ( 5 )$$

Due to the fact that the Lambert W function is monotonically increasing, the minimum is located in x∈[−∞, 0] when β≥0 and in x∈[0, 1] when β₀<β<0. Although the Lambert W function may not be able to be expressed in term of elementary functions, it is implemented in math libraries, such as the Python math library. For example, a precomputed piece-wise approximation of the function may be used, which can be easily implemented on a graphical processing unit (GPU) in PyTorch using the grid_sample( ) function. In the case where β≤β₀, the optimal confidence may be capped (limited) at

$${σ}^{*} = {e}^{- W ( \frac{{β}_{0}}{2} )} = e .$$

In summary:

$${σ}_{λ}^{*} ( ℓ ) = {e}^{- W ( \frac{1}{2} max ( {β}_{0} , β ) )} , with β = \frac{ℓ - τ}{λ} \qquad ( 6 )$$

Thus, the optimal confidence σ*( [symbol] ) has a closed form solution that only depends on the ratio

$$\frac{ℓ - τ}{λ} .$$

The SuperLoss function becomes equivalent to the original input loss when λ trends to infinity. As a corollary of equation (6), the following is obtained:

$${lim}_{λ \to + ∞} {σ}_{λ}^{*} = {e}^{- W ( 0 )} = 1 , \\ hence$$

$${lim}_{λ \to + ∞} {SL}_{λ}^{*} ( ℓ ) = {lim}_{λ \to + ∞} {σ}_{λ}^{*} ( ℓ ) ( ℓ - τ ) + {π ( log {σ}_{λ}^{*} ( ℓ ) )}^{2} , \\ {lim}_{λ \to + ∞} {SL}_{λ}^{*} ( ℓ ) = {lim}_{λ \to + ∞} ℓ - τ + λ {W ( \frac{ℓ - τ}{2 λ} )}^{2}$$

$${lim}_{λ \to + ∞} {SL}_{λ}^{*} ( ℓ ) = {lim}_{λ \to + ∞} ℓ - τ + \frac{{( ℓ - τ )}^{2}}{4 λ}$$

$${lim}_{λ \to + ∞} {SL}_{λ}^{*} ( ℓ ) = ℓ - τ .$$

Since τ is considered a constant, the SuperLoss function is equivalent to the input loss [symbol] at the limit.

Due to the fact that σ* only depends on the ratio

$$\frac{( ℓ - τ )}{λ}$$

(see equation b) and if it is assumed that τ is proportional to [symbol] because it is computed as a running average of [symbol] , then:

σ*_{γλ}(γ [symbol] )=σ*_{λ}( [symbol] ) (7)

It naturally follows that:

SL*_{γλ}(γ [symbol] )=σ*_{γλ}(γ [symbol] )(γ [symbol] −γτ)+γλ(log σ*_{γλ}γ [symbol] ))²

SL*_{γλ}(γ [symbol] )=σ*_{λ}( [symbol] )(γ [symbol] −γτ)+γλ(log σ*_{λ}( [symbol] ))²

SL*_{γλ}(γ [symbol] )=γ(σ*_{γλ}( [symbol] )( [symbol] −τ)+γλ(log σ*_{λ}( [symbol] ))²

SL*_{γλ}(γ [symbol] )=γSL*_{λ}( [symbol] ) (8)

In other words, the SuperLoss function is a homogeneous function, i.e., SL*_{γλ}(γ [symbol] )=γSL*_{λ}( [symbol] ), ∀_{γ}>0.

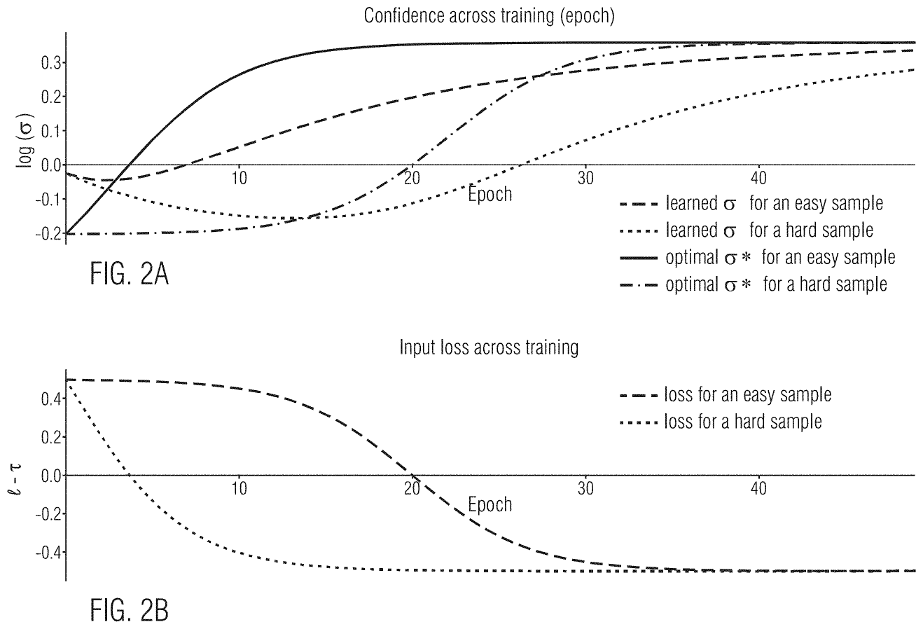

Deducing the confidence of each sample automatically from the prediction loss as described above provides advantages over learning the confidence of each sample via back propagation. First, it does not require an extra learnable parameter per sample, meaning the SuperLoss function can scale for tasks where the number of samples can be almost infinite. Second, learning the confidence may introduce a delay (i.e., the times convergence), and this potential inconsistency between the true status of the sample and its respective confidence. This is illustrated by FIG. 2A which shows losses produced by an easy and a hard sample during training and FIG. 2B which shows (a) their respective confidence when learned via back propagation using SL( [symbol] , σ) (dotted lines) and (b) their optimal confidence σ* (plain lines). In contrast to using the optimal confidence, learning it induces a delay between the moment a sample becomes easy (its loss passes under τ) and the moment its confidence becomes greater than 1. Third, it adds several hyperparameters on top of the baseline approach for the dedicated optimizes such as learning rate weight decay.

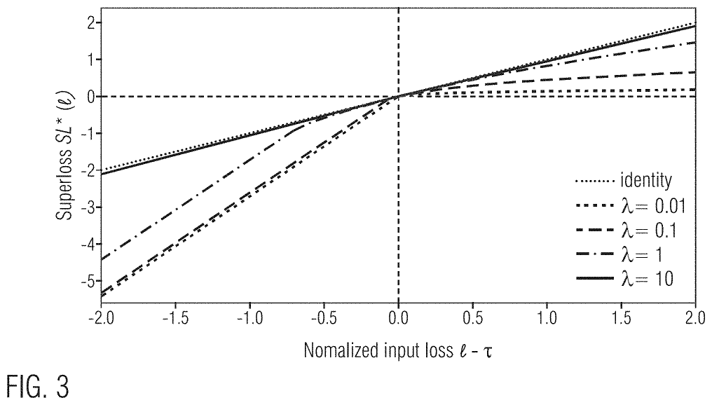

FIG. 3 illustrates SuperLoss SL*( [symbol] )=SL( [symbol] ,σ*( [symbol] )) as a function of the normalized input loss [symbol] −τ. FIG. 3 shows that this formulation meets the requirements outlined above. Each curve corresponds to a different value of the regularization hyperparameter λ.

Regardless of how the confidence intervenes in the formula, a property of the SuperLoss function is that the gradient of the loss with respect to the network parameters should monotonically increase with the confidence, all other parameters staying fixed. For example, the (log σⁱ)² term of equation (4), which acts as a log-normal prior on the scale parameter, may be replaced by a different prior. Another possibility is to use a mixture model in which the original loss is the log-likelihood of one mixture component and a second component models the noise (e.g., as a uniform distribution over the labels).

As can be seen from the above, there are differences between SuperLoss function and other curriculum losses. First, the SuperLoss function is applied individually for each sample at the lowest level. Second, the SuperLoss function includes an additional regularization term λ that allows the SuperLoss function to handle losses of different amplitudes and different levels of noise in the training dataset. Third, the SuperLoss function makes no assumption on the range and minimum value of the loss, thereby introducing a dynamic threshold and a squared log of the confidence for the regularization. The confidence directly corresponds to the weighting of the sample losses in the SuperLoss, which makes the confidence easily interpretable. The relation between confidence and sample weighting is not necessarily obvious for other confidence-aware losses.

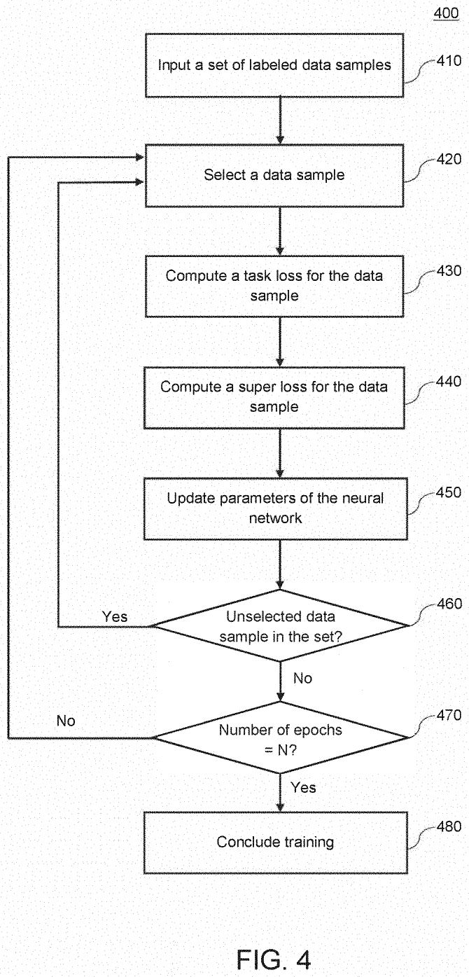

FIG. 4 is a flow diagram of a method 400 of training a neural network using the SuperLoss function described above. At 410, a batch of data samples to be processed by the neural network is obtained, where a batch comprises a number of randomly-selected data samples.

At 420, a task loss is computed using a first loss function corresponding to the task to be performed by the neural network. The task loss corresponds to an error in the prediction (relative to a target prediction) for each data sample of the batch. The task loss is then input into a second loss function (the SuperLoss function). Based on the task loss, the SuperLoss function computes a second loss (the super loss) for each data sample of the batch at 430. The SuperLoss function computes the weight of each data sample based on the task loss associated with the respective data sample. Specifically, as described above, the SuperLoss function increases the weight (value) of the data sample if the task loss is below a threshold value, τ, and decreases the weight (value) of the data sample if the task loss is greater than the threshold value.

In some embodiments, as described above, computing the SuperLoss function may include computing a value of the confidence parameter σ* based on the task loss for the respective data sample. Computing the value of the confidence parameter σ* includes determining the value of the confidence parameter that minimizes the SuperLoss function for the task loss associated with the data sample.

At 440 the SuperLoss function determines a SuperLoss (value) for the data sample, as described above. At 450, the SuperLoss is used to update one or more of the learnable parameters of the neural network. In other words, one or more learnable parameters of the neural network are updated based on the SuperLoss value.

At 460, a determination is made as to whether there are more data samples in the set to be processed by the neural network. If there remains one or more unselected data samples, the method returns to step 420 where another data sample is selected from the set. The set of labeled data samples is processed a fixed number of times (epochs) N, where each of the data samples of the set is selected and processed once in each epoch. If all of the data samples have been processed, a determination is made at step 470 as to whether N epochs have been performed. If fewer than N epochs have been performed, the method returns to step 420. Alternatively, the method may return to 410 and receive a new set of labeled data samples. If N epochs have been performed, training is concluded at step 480.

At this stage, the neural network has been trained and the trained neural network can be tested and used to process unseen data.

Regarding applications of the SuperLoss function, as described above, the SuperLoss function is a task-agnostic loss function that may be used to train a neural network to perform various different tasks. In some embodiments, the neural network is trained to perform image processing tasks such as classification, regression, object detection, image retrieval, or another suitable image processing task.

Regarding classification, the Cross-Entropy loss (CE) may be straightforwardly input to the SuperLoss: SL*_{CE}=SL*( [symbol] _{CE}(ƒ(x), y)). The threshold value τ may be fixed and set to τ=log C, where C is the number of classes, representing the cross-entropy of a uniform prediction and hence a natural boundary between correct and incorrect prediction.

Regarding regression, a regression loss [symbol] _{reg} such as the smooth-L1 loss (smooth- [symbol] ₁) or the Mean-Square-Error (MSE) loss ( [symbol] ₂) can be input into the SuperLoss. The range of values for a regression loss may differs from the range of values of the CE loss, but this is not an issue for the SuperLoss function in view of the regularization term controlled by λ.

Regarding object detection, the SuperLoss function may be applied on the box classification component of two object detection frameworks, such as the faster recursive convolutional neural network (Faster R-CNN) framework. The Faster R-CNN framework is described in Shaoquing R., et al., Faster R-CNN: Towards real-time object detection with region proposal networks, NIPS, 2015, and Lin, T. Y., et al., Focal Loss for dense object detection, ICCV, 2017, which are incorporated herein in their entireties. Faster R-CNN classification loss may include a standard cross-entropy loss [symbol] _{CE} on which the SuperLoss function is added SL*_{CE}. RetinaNet classification loss may include a class-balanced focal loss (FL): [symbol] _{FL}(pⁱ, yⁱ)=−α_{y}_{ⁱ}(1−p_{y}_{ⁱ}ⁱ)^{γ} log(p_{y}_{ⁱ}ⁱ) with pⁱ the probabilities predicted by the network for each box obtained with a softmax on the logits zⁱ=ƒ(xⁱ). In contrast to classification, object detection may involve a number of negative detections, for which it may be infeasible to store or learn individual confidences. In contrast to approaches that learn a separate weight per sample the method described herein may estimate the confidence of positive and negative detections on the fly from their loss only.

Regarding retrieval and metric learning, the SuperLoss function may be applied to image retrieval using a contrastive loss, such as described in Hadsell R. et al., Dimensionality reduction by learning an invariant mapping, CVPR, 2006, which is incorporated herein in its entirety. In this case, the training set {(xⁱ, xⁱ, y^{ij})}ᵢⱼ includes pairs of samples labeled either positively (y^{ij}=1) or negatively (y^{ij}=0). The goal is to learn a latent representation where positive pairs lie close whereas negative pairs may be far apart. The contrastive loss may include two losses: [symbol] _{CL}_{⁺}(ƒ(xⁱ), ƒ(x^{j}))=[∥ƒ(xⁱ)−ƒ(x^{j})∥]₊ for positive pairs (y^{ij}=1) and [symbol] _{CL}_{^{−}}(ƒ(xⁱ), ƒ(x^{j}))=[m−∥ƒ(xⁱ)−ƒ(x^{j})∥]₊ for negative pairs (y^{ij}=0) where m>0 is a margin. A null margin for positive pairs may be assumed and [⋅]₊ denotes the positive component. The SuperLoss function may be applied on top of each of the two losses, i.e., with two independent thresholds τ, but sharing the same regularization parameter λ for simplicity:

$${SL}_{λ , CL}^{*} ( f ( {x}^{i} ) , f ( {x}^{j} ) , {y}^{ij} ) = \{ \begin{matrix}{SL}_{λ}^{*} ( {ℓ}_{CL +} ( f ( {x}^{i} ) , f ( {x}^{j} ) ) ) , & {y}^{ij} = 1 \\ {SL}_{λ}^{*} ( {ℓ}_{CL -} ( f ( {x}^{i} ) , f ( {x}^{j} ) ) ) , & {y}^{ij} = 0\end{matrix}$$

The same strategy can be applied to other metric learning losses, such as the triplet loss, such as described in Weinberger K. Q. et al., Distance metric learning for large margin nearest neighbor classification, JMLR, 2009, which is incorporated herein in its entirety. As for object detection, approaches that explicitly learn or estimate the importance of each sample may not be applicable to metric learning because (a) the number of potential pairs or triplets may be too large, making intractable to store their weight in memory; and (b) only a small fraction of them is seen at each epoch, which prevents the accumulation of enough evidence.

### Experimental Results

Empirical evidence is presented below that the approach described above leads to consistent gains when applied to clean and noisy training datasets. The results are shown for the SuperLoss function shown in equation (3). In particular, large gains are observed in the case of training from noisy data, which may be common for large-scale training datasets automatically collected from the web.

### Experimental Protocol

The neural network model trained with the original task loss is referred to as the baseline. The protocol involved first training the baseline and tuning its hyperparameters (e.g., learning rate, weight decay, etc.) using held-out validation for each noise level. For a fair comparison between the baseline and the SuperLoss function, the model is trained with the SuperLoss function with the same hyperparameters. Unlike other techniques, special warm-up periods or other tricks are not required for the SuperLoss function.

Hyperparameters specific to the SuperLoss function (e.g., regularization λ and loss threshold τ) were either fixed or tuned using held-out validation or cross-validation. There may be three options for τ: (1) a fixed value given by prior knowledge on the task at hand; (2) a global average of the loss so far, denoted as ‘Avg’; or (3) an exponential running average with a fixed smoothing parameter α=0.9, denoted as ‘ExpAvg’. Similar to the smoothing described in Nguyen Duc T., et al., SELF: learning to filter noisy labels with self-ensembling, ICLR, 2019, which is incorporated herein in its entirety, the individual sample losses input to the SuperLoss function are smoothed in equation (3) using exponential averaging with α′=0.9, as the smoothing may make the training more stable. This strategy may only be applicable for limited size datasets.

### Evaluation of Superloss for Regression

The SuperLoss function is evaluated on digit regression as described in LeCun Y. et al., MNIST handwritten digit database, ICPR, 2010 and on human age regression on the dataset described in Zhang Z. et al., Age progression/regression by conditional adversarial autoencoder, CVPR, 2017, with both a robust loss (smooth- [symbol] ₁) and a non-robust loss ( [symbol] ₂), and with different noise levels.

Regarding digit regression, a toy regression experiment is performed on the MNIST dataset by considering the original digit classification problem as a regression problem. Specifically, the output dimension of LeNet is set to 1 instead of 10 and trained using a regression loss for 20 epochs using SGD (Stochastic Gradient Descent). The hyperparameters of the baseline are cross validated for each loss and noise level. Typically, [symbol] ₂ may prefer a lower learning rate compared to smooth- [symbol] ₁. For the SuperLoss, a fixed threshold τ=0.5 is experimented with as it is an acceptable bound for regressing the right integer.

Regarding age regression, the UTKFace dataset is experimented with, which includes 23,705 aligned and cropped face images, randomly split into 90% for training and 10% for testing. Races, genders, and ages (between 1 to 116 years old) widely vary and are represented in imbalanced proportions, making the age regression task challenging. A ResNet-18 model (with a single output) is used, initialized on ImageNet as predictor and trained for 100 epochs using SGD. The hyperparameters are cross-validated for each loss and noise level. Because it is not clear which fixed threshold would be optimal for this task, a fixed threshold is not used in the SuperLoss function.

### Results

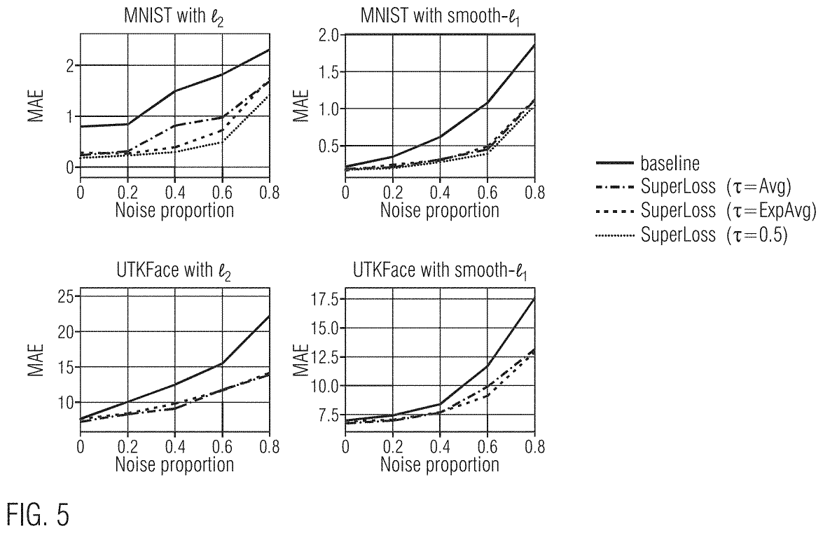

To evaluate the impact of noise when training, noise is generated artificially using a uniform distribution between 1 and 10 for digits and between 1 and 116 for ages. FIG. 5 illustrates the mean absolute error (MAE) on digit regression and human age regression as a function of noise proportion, for a robust loss (smooth- [symbol] ₁) and a non-robust loss ( [symbol] ₂). The MAE is aggregated over 5 runs for both datasets and both losses with varying noise proportions.

Models trained using the SuperLoss function outperform the baseline by some margin, regardless of the noise level or the τ threshold. This is particularly true when the neural network is trained with a non-robust loss ( [symbol] ₂), suggesting that the SuperLoss function makes a non-robust loss more robust. Even when the baseline is trained using a robust loss (smooth- [symbol] ₁), the SuperLoss function still significantly reduces the error (e.g., from 17.56±0.33 to 13.09±0.05 on UTKFace at 80% noise). Note that the two losses have drastically different ranges of amplitudes depending on the task (e.g., [symbol] ₂ for age regression typically ranges in [0, 10000] while smooth- [symbol] ₁ for digit regression ranges in [0, 10]).

During cross-validation of the hyper-parameters, it may be important to use a robust error metric to choose the best parameters, otherwise noisy predictions may have too much influence on the results. Thus a truncated absolute error min(t, |y−ŷ|) may be used, where y and ŷ are the true value and the prediction, respectively, and τ is a threshold set to 1 for the MNIST dataset and 10 for the UTKFace dataset.

Table 1 provides experimental results for digit regression in term of mean absolute error (MAE) aggregated over 5 runs (mean±standard deviation) on the task of digit regression on the MINIST dataset.

TABLE 1

| | | Proportion of Noise | | | | |
|---|---|---|---|---|---|---|
| Input Loss | Method | 0% | 20% | 40% | 60% | 80% |
| MSE(l₂) | Baseline | 0.80 ± 0.87 | 0.84 ± 0.17 | 1.49 ± 0.53 | 1.83 ± 0.36 | 2.31 ± 0.19 |
| | SuperLoss | 0.18 ± 0.01 | 0.23 ± 0.01 | 0.29 ± 0.02 | 0.49 ± 0.06 | 1.43 ± 0.17 |
| Smooth-l₁ | Baseline | 0.21 ± 0.02 | 0.35 ± 0.01 | 0.62 ± 0.03 | 1.07 ± 0.05 | 1.87 ± 0.06 |
| | SuperLoss | 0.18 ± 0.01 | 0.21 ± 0.01 | 0.28 ± 0.01 | 0.39 ± 0.01 | 1.04 ± 0.02 |

Table 2 provides experimental results for age regression in term of mean absolute error (MAE) aggregated over 5 runs (mean±standard deviation) on the task of digit regression on the UTKFace dataset.

TABLE 2

| | | Proportion of Noise | | | | |
|---|---|---|---|---|---|---|
| Input Loss | Method | 0% | 20% | 40% | 60% | 80% |
| MSE(l₂) | Baseline | 7.60 ± 0.16 | 10.05 ± 0.41 | 12.47 ± 0.73 | 15.42 ± 1.13 | 22.19 ± 3.06 |
| | SuperLoss | 7.24 ± 0.47 | 8.35 ± 0.17 | 9.10 ± 0.33 | 11.74 ± 0.14 | 13.91 ± 0.13 |
| Smooth-l₁ | Baseline | 6.98 ± 0.19 | 7.40 ± 0.18 | 8.38 ± 0.08 | 11.62 ± 0.08 | 17.56 ± 0.33 |
| | SuperLoss | 6.74 ± 0.14 | 6.99 ± 0.09 | 7.65 ± 0.06 | 9.86 ± 0.27 | 13.09 ± 0.05 |

### Evaluation of Superloss for Image Classification

The CIFAR-10 and CIFAR-100 datasets include 50,000 training and 10,000 test images belonging to C=10 and C=100 classes respectively. A WideResNet-28-10 model is trained with the SuperLoss function, strictly following the experimental settings and protocol described in Data parameters: a new family of parameters for learning a differentiable curriculum, NeurIPS, 2019, for comparison purpose. The regularization parameter was set to λ=1 for the CIFAR-10 dataset and to λ=0.25 for the CIFAR-100 dataset.

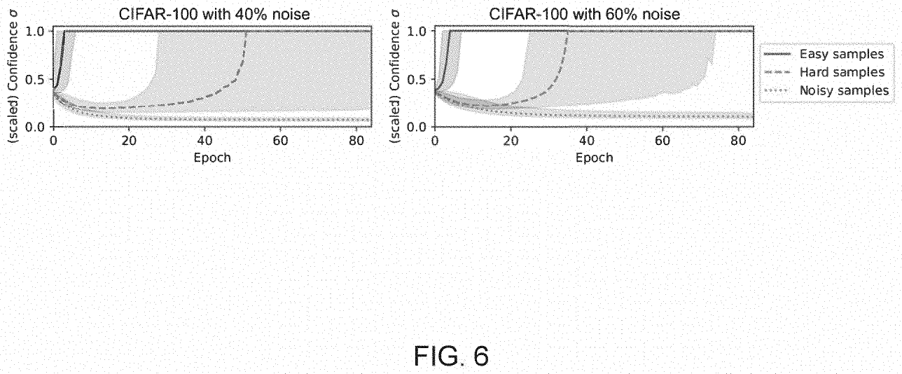

FIG. 6 illustrates the evolution of the confidence σ* from Equation (3) during training (median value and 25-75% percentiles) for easy, hard, and noisy samples. Hard samples may be defined as correct samples failing to reach high confidence within the first 20 epochs of training. As training progresses, noisy and hard samples get more clearly separated.

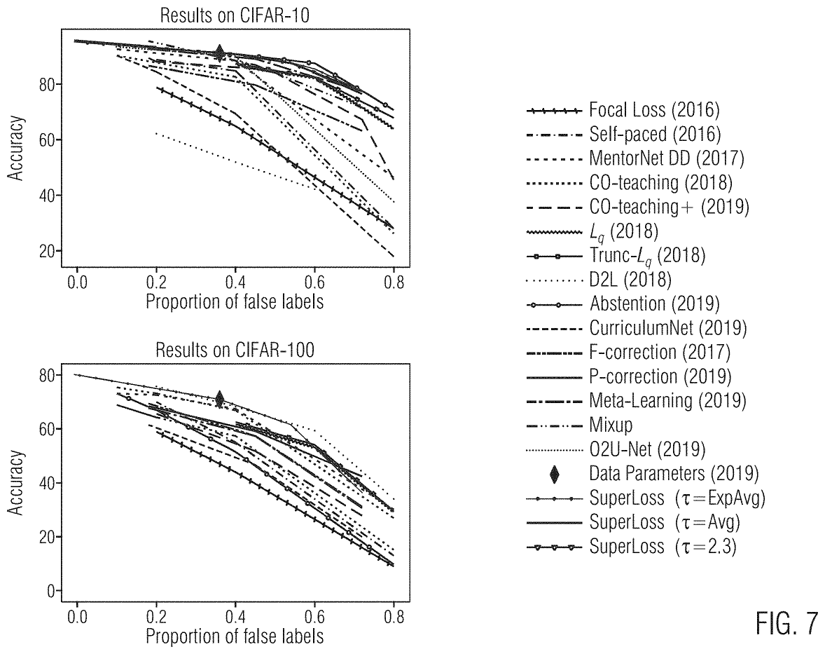

FIG. 7 shows plots of accuracy of CIFAR-10 and CIFAR-100 as a function of the proportion of noise for the SuperLoss function and other methods. The results (averaged over 5 runs) are included for different proportions of corrupted labels. A very similar performance regardless of τ (either fixed to log C or using automatic averaging) is observed.

On clean datasets, the SuperLoss function slightly improves over the baseline (e.g., from 95.8%±0.1 to 96.0%±0.1 on CIFAR-10) even though the performance is quite saturated. In the presence of symmetric noise, the SuperLoss function generally performs better than other approaches. The SuperLoss function performs on par with a confidence-aware loss, confirming that confidence parameters may not need to be learned. The SuperLoss function outperforms other more complex and specialized methods, even though classification is not specifically targeted, a special training procedure is not used, and there is no change in the network.

The WebVision dataset is a large-scale dataset including 2.4 million images with C=1000 classes, automatically gathered from the web by querying search engines with the class names. It thus inherently contains a significant level of noise. Following the experimental settings and protocol described above, a ResNet-18 model was trained using SGD for 120 epochs with a weight decay of 10⁻⁴, an initial learning rate of 0.1, divided by 10 at 30, 60, and 90 epochs. The regularization parameter for the SuperLoss function was set to λ=0.25 and a fixed threshold for τ=log(C) was used. The final accuracy is 66.7%±0.1 which represents a consistent gain of +1.2% (aggregated over 4 runs) compared to the baseline (65.5%±0.1). This gain is free as the SuperLoss function does not require any change in terms of training time or engineering efforts.

In experiments on the CIFAR-10 and CIFAR-100 datasets, the SuperLoss function has been compared to other approaches under different proportions of corrupted labels. More specifically, what is commonly defined as symmetric noise was used, i.e., a predetermined proportion of the training labels are replaced by other labels drawn from a uniform distribution. Detailed results for the two following cases are provided in Tables 3 and 4: (a) the new (noisy) label can remain equal to the original (true) label; and (b) the new label is drawn from a uniform distribution that exclude the true label. In those tables, the SuperLoss (SL) function is compared to other approaches including: Self-paced (described in Kumar P. M. et al., Self-paced learning for latent variable models, NIPS, 2010), Focal Loss (described in Lin T. Y. et al., Focal loss for dense object detection, ICCV, 2017), MentorNet DD (described in Jiang, L. et al., Mentornet: Learning data-driven curriculum for very deep neural networks on corrupted labels, ICML, 2018), Forgetting (described in Arpit D. et al., A closer look at memorization in deep networks, ICML, 2017), Co-Teaching (described in Han B. et al., Co-teaching: Robust training of deep neural networks with extremely noisy labels, NeurIPS, 2018), L_{q} and Trunc L_{q} (described in Zhang Z. et al., Generalized cross entropy loss for training deep neural networks with noisy labels, NeurIPS, 2018), Reweight (described in Ren M. et al., Learning to reweight examples for robust deep learning, ICML, 2018), D2L (described in Ma X. et al., Dimensionality-driven learning with noisy labels, ICML, 2018), Forward T (described in Quin Z. et al., Making deep neural networks robust to label noise: Cross-training with a novel loss function, IEEE access, 2019), SELF (described in Nguyen Duc T. et al., Self: learning to filter noisy labels with self-ensembling, ICLR, 2019), Abstention (described in Thulasidasan S. et al., Combating label noise in deep learning using abstention, ICML, 2019), Curriculum Net (described in Sheng et al., Curriculumnet: Weakly-supervised learning for large-scale web images, ECCV, 2018), O2U-net(50) and O2Unet(10) (described in Jinchi H. et al., O2U-Net: A simple noisy label detection approach for deep neural networks, ICCV, 2019), DivideMix (described in Li J. et al., Dividemix: Learning with noisy labels as semi-supervised learning, ICLR, 2020), Curriculum Loss (described in Lyu Y. et al., Curriculum loss: Robust learning and generalization against label corruption, ICLR, 2020), Bootstrap (described in Reed S. et al., Training deep neural networks on noisy labels with bootstrapping, ICLR, 2015), F-correction (described in Patrini G. et al., Making deep neural networks robust to label noise: A loss correction approach, CVPR, 2017), Mixup (described in Zhang H. et al., Mixup: Beyond empirical risk minimization, ICLR, 2018), C-teaching+ (described I Yu X. et al., How does disagreement help generalization against label corruption?, ICML, 2019), P-Correction (described in Yi K. et al., Probabilistic end-to-end noise correction for learning with noisy labels, CVPR, 2019), Meta-Learning (described in Li J. et al., Learning to learn from noisy labeled data, CVPR, 2019), and Data Parameters (described in Saxena S. et al., Data parameters: A new family of parameters for learning a differentiable curriculum, NeurIPS, 2019).

As can be seen from Tables 3 and 4, the SuperLoss (SL*) function performs on par or better than most of the other approaches, including ones specifically designed for classification and requiring dedicated training procedure. SELF and DivideMix may outperform the SuperLoss function, but they share the aforementioned limitations as they both rely on ensembles of networks to strongly resist memorization. In contrast, the SuperLoss approach uses a single network trained with a baseline procedure without any special architecture and/or training.

TABLE 3

| | CIFAR-10 | | | CIFAR-100 | | |
|---|---|---|---|---|---|---|
| Method | 20% | 40% | 60% | 20% | 40% | 60% |
| Self-paced | 89.0 | 85.0 | — | 70.0 | 55.0 | — |
| Focal Loss | 79.0 | 65.0 | — | 59.0 | 44.0 | — |
| MentorNet DD | 91.23 | 88.64 | — | 72.64 | 67.51 | — |
| Forgetting | 78.0 | 63.0 | — | 61.0 | 44.0 | — |
| Co-Teaching | 87.26 | 82.80 | — | 64.40 | 57.42 | — |
| L_{q} | — | 87.13 | 82.54 | — | 61.77 | 53.16 |
| Trunc L_{q} | — | 87.62 | 82.70 | — | 62.64 | 54.04 |
| Reweight | 86.9 | — | — | 61.3 | — | — |
| D2L | 85.1 | 83.4 | 72.8 | 62.2 | 52.0 | 42.3 |
| Forward \hat{T} | — | 83.25 | 74.96 | — | 31.05 | 19.12 |
| SELF | — | 93.70 | 93.15 | — | 71.98 | 66.21 |
| Abstention | 93.4 | 90.9 | 87.6 | 75.8 | 68.2 | 59.4 |
| CurriculumNet | 84.65 | 69.45 | — | 67.09 | 51.68 | — |
| O2U-net(10) | 92.57 | 90.33 | — | 74.12 | 69.21 | — |
| O2U-net(50) | 91.60 | 89.59 | — | 73.28 | 67.00 | — |
| DivideMix | 96.2 | 94.9 | 94.3 | 77.2 | 75.2 | 72.0 |
| CurriculumLoss | 89.49 | 83.24 | 66.2 | 64.88 | 56.34 | 44.49 |
| SL*, τ = logC | 93.31 ± 0.19 | 90.99 ± 0.19 | 85.39 ± 0.46 | 75.54 ± 0.26 | 69.90 ± 0.24 | 61.01 ± 0.25 |
| SL*, τ = Avg | 93.16 ± 0.17 | 91.05 ± 0.18 | 85.52 ± 0.53 | 75.02 ± 0.08 | 71.06 ± 0.17 | 61.96 ± 0.11 |
| SL*, τ = ExpAvg | 92.98 ± 0.11 | 91.06 ± 0.23 | 85.48 ± 0.13 | 74.34 ± 0.26 | 70.96 ± 0.26 | 62.39 ± 0.17 |

TABLE 4

| | CIFAR-10 | | | | CIFAR-100 | | | |
|---|---|---|---|---|---|---|---|---|
| Method | 20% | 40% | 60% | 80% | 20% | 40% | 60% | 80% |
| Bootstrap | 86.8 | — | 79.8 | 63.3 | 62.1 | — | 46.6 | 19.9 |
| F-correction | 86.8 | — | 79.8 | 63.3 | 61.5 | — | 46.6 | 19.9 |
| Mixup | 95.6 | — | 87.1 | 71.6 | 67.8 | — | 57.3 | 30.8 |
| Co-teaching+ | 89.5 | — | 85.7 | 67.4 | 65.6 | — | 51.8 | 27.9 |
| P-Correction | 92.4 | — | 89.1 | 77.5 | 69.4 | — | 57.5 | 31.1 |
| Meta-Learning | 92.9 | — | 89.3 | 77.4 | 68.5 | — | 59.2 | 42.4 |
| Data Parameters | — | 91.10 ± 0.70 | — | — | — | 70.93 ± 0.15 | — | — |
| DivideMix | 96.1 | — | 94.6 | 93.2 | 77.3 | — | 74.6 | 60.2 |
| SL*, τ = logC | 93.39 ± 0.12 | 91.73 ± 0.17 | 90.11 ± 0.18 | 77.42 ± 0.29 | 74.76 ± 0.06 | 69.89 ± 0.07 | 66.67 ± 0.60 | 37.91 ± 0.93 |
| SL*, τ = Avg | 93.16 ± 0.17 | 91.55 ± 0.18 | 90.21 ± 0.22 | 76.79 ± 0.60 | 74.73 ± 0.17 | 71.05 ± 0.08 | 67.84 ± 0.25 | 36.40 ± 0.09 |
| SL*, τ = ExpAvg | 93.03 ± 0.12 | 91.70 ± 0.33 | 89.98 ± 0.18 | 77.49 ± 0.29 | 74.65 ± 0.31 | 70.98 ± 0.26 | 67.21 ± 0.33 | 36.45 ± 0.80 |

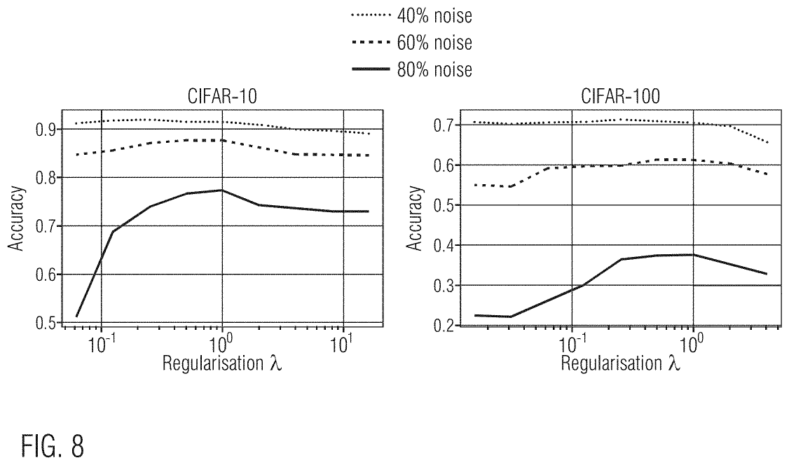

FIG. 8 shows the impact of the regularization parameter λ on CIFAR-10 and CIFAR-100 for different proportions of label corruption. τ=ExpAvg was used. Overall, the regularization has a moderate impact on the classification performance. At the exception of very high level of noise (80%), the performance plateaus for a relatively large range of regularization values. Importantly, a maximum value of A is approximately the same for all noise levels, indicating that the SuperLoss method can cope well with the potential variance of training sets in real use-cases.

### Evaluation of Superloss for Object Detection

Experiments were performed for the object detection task on the Pascal VOC dataset and its noisy version where symmetric label noise is applied to 20%, 40%, or 60% of the instances. Two object detection frameworks from detectron2 were used: Faster R-CNN (described in Shaoquing R. et al., Faster R-CNN: Towards real-time object detection with region proposal networks, NIPS, 2015) and RetinaNet (described in Tsung-Yi, L. et al., Focal loss for dense object detection, ICCV, 2017).

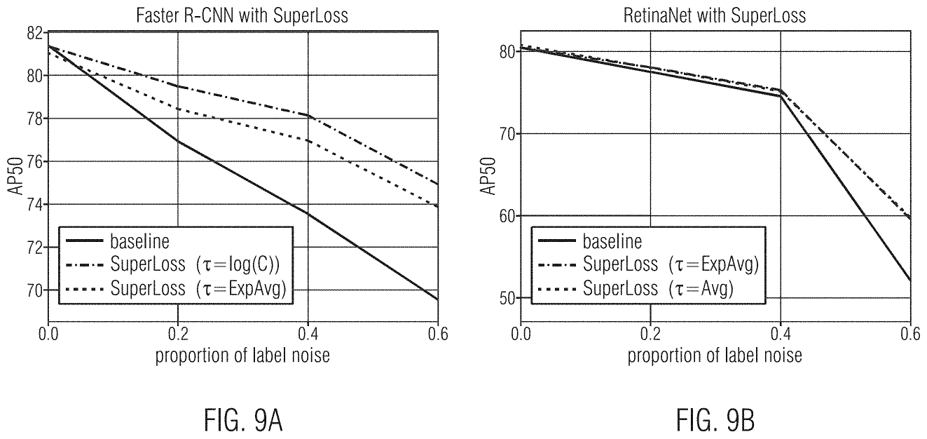

FIGS. 9A-9B show the standard AP50 metric for varying levels of noise using the SuperLoss function, where the standard box classification loss is used as the baseline. Mean and standard deviation over 3 runs is shown. For the baseline, the default parameters from detectron2 have been used. For the SuperLoss, λ=1 for clean data and λ=0.25 for any other level of noise has been used, in all experiments, for both Faster R-CNN (as shown in FIG. 9A) and RetinaNet (as shown in FIG. 9B).

While the baseline and the SuperLoss are on par on clean data, the SuperLoss again outperforms the baseline in the presence of noise. For instance, the performance drop (between 60% of label noise and clean data) is reduced from 12% to 8% for Faster R-CNN, and from 29% to 20% for Retina-Net. For τ, a slight edge may be observed for τ=log (C) with Faster R-CNN. The same fixed threshold do not apply to RetinaNet as it does not rely on cross-entropy loss, but global and exponential averaging perform similarly.

Table 5 compares the SuperLoss function to some other noise-robust approaches: Co-teaching (described in Han B. et al, Co-teaching: Robust training of deep neural networks with extremely noisy labels, NeurIPS, 2018), SD-LocNet (described in Xiaopeng Z. et al., Learning to localize objects with noisy label instances, AAAI, 2019), Note-RCNNN (described in Gao J. et al., Note-RCNNN: Noise tolerant ensemble RCNNN for semi-supervised object detection, ICCV, 2019) and CA-BBC (described in Li J. et al., Towards noise-resistant object detection with noisy annotations, ArXiv: 2003.01285, 2020).

TABLE 5

| | Label | | | | |
|---|---|---|---|---|---|
| | Noise | 0% | 20% | 40% | 60% |
| RetinaNet | Baseline | 80.6 | 77.5 | 74.6 | 52.0 |
| | SuperLoss | 80.5 | 78.1 | 75.3 | 59.6 |
| | (τ = | | | | |
| | ExpAvg) | | | | |
| | SuperLoss | 80.7 | 78.0 | 75.2 | 59.7 |
| | (τ = Aug) | | | | |
| Faster | baseline | 81.4 | 76.9 | 73.6 | 69.5 |
| R-CNN | SuperLoss | 81.4 | 79.5 | 78.1 | 74.9 |
| | (τ = | | | | |
| | ExpAvg) | | | | |
| | SuperLoss | 81.0 | 78.4 | 77.0 | 73.8 |
| | (τ = Aug) | | | | |
| | Co-teaching | 78.3 | 76.5 | 74.1 | 69.9 |
| | SD-LocNet | 78.0 | 75.3 | 73.0 | 66.2 |
| | Note | 78.6 | 75.3 | 74.9 | 69.9 |
| | RCNNN | | | | |
| | CA-BBC | 80.1 | 79.1 | 77.7 | 74.1 |

Once again, the simple and generic SuperLoss outperforms other approaches including approaches leveraging complex strategies to identify and/or correct noisy samples.

Tables 6, 7, and 8 show a comparison of SuperLoss with the baseline and other object detection using the AP, AP50, and AP75 metrics on the Pascal VOC dataset. The tables also show the AP75 metric (i.e., the mean average precision (mAP) at a higher intersection-over-union (IoU) threshold of 0.75 instead of 0.5), as well as the AP metric, which is the average of mAP at varying IoU thresholds. For the baseline and the SuperLoss function, both the mean and the standard deviation over 3 runs are reported. With both Faster R-CNN and RetinaNet object detection frameworks, it is observed that the SuperLoss provides a significantly increase the performance of the baseline in the presence of noise for all metrics. Interestingly, the SuperLoss also significantly reduces the variance of the model, which may be pretty high in the presence of noise, in particular with RetinaNet.

TABLE 6
AP

| | Label | | | | |
|---|---|---|---|---|---|
| | noise | 0% | 20% | 40% | 60% |
| RetinaNet | Baseline | 54.9 ± 0.5 | 51.0 ± 0.2 | 48.7 ± 0.3 | 34.9 ± 0.6 |
| | SuperLoss | 54.8 ± 0.6 | 52.1 ± 0.4 | 49.8 ± 0.1 | 39.3 ± 0.3 |
| | (τ = | | | | |
| | ExpAvg) | | | | |
| | SuperLoss | 55.3 ± 0.1 | 52.3 ± 0.4 | 49.8 ± 0.3 | 39.3 ± 1.0 |
| | (τ = Aug) | | | | |
| Faster | Baseline | 53.2 ± 0.2 | 47.3 ± 0.3 | 44.5 ± 0.3 | 41.5 ± 0.5 |
| R-CNN | SuperLoss | 52.7 ± 0.1 | 50.8 ± 0.1 | 49.3 ± 0.1 | 46.6 ± 0.2 |
| | (τ = | | | | |
| | ExpAvg) | | | | |
| | SuperLoss | 52.5 ± 0.2 | 49.0 ± 0.2 | 48.5 ± 0.3 | 46.4 ± 0.3 |
| | (τ = Avg) | | | | |

TABLE 7
AP50

| | Label | | | | |
|---|---|---|---|---|---|
| | noise | 0% | 20% | 40% | 60% |
| RetinaNet | Baseline | 80.6 ± 0.2 | 77.5 ± 0.6 | 74.6 ± 0.6 | 52.0 ± 3.3 |
| | SuperLoss | 80.5 ± 0.4 | 78.1 ± 0.2 | 75.3 ± 0.0 | 59.6 ± 0.2 |
| | (τ = | | | | |
| | ExpAvg) | | | | |
| | SuperLoss | 80.7 ± 0.2 | 78.0 ± 0.1 | 75.2 ± 0.8 | 59.7 ± 1.6 |
| | (τ = Avg) | | | | |
| Faster | Baseline | 81.4 ± 0.0 | 76.9 ± 0.2 | 73.6 ± 0.2 | 69.5 ± 0.4 |
| R-CNN | SuperLoss | 81.4 ± 0.1 | 79.5 ± 0.3 | 78.1 ± 0.1 | 74.9 ± 0.1 |
| | (τ = | | | | |
| | ExpAvg) | | | | |
| | SuperLoss | 81.0 ± 0.2 | 78.4 ± 0.1 | 77.0 ± 0.3 | 73.8 ± 0.4 |
| | (τ = Aug) | | | | |
| | Co-teaching | 78.3 | 76.5 | 74.1 | 69.9 |
| | SD-LocNet | 78.0 | 75.3 | 73.0 | 66.2 |
| | Note | 78.6 | 75.3 | 74.9 | 69.9 |
| | RCNNN | | | | |
| | CA-BBC | 80.1 | 79.1 | 77.7 | 74.1 |

TABLE 8
AP75

| | Label | | | | |
|---|---|---|---|---|---|
| | noise | 0% | 20% | 40% | 60% |
| RetinaNet | Baseline | 59.7 ± 0.5 | 55.6 ± 0.7 | 51.8 ± 0.5 | 36.8 ± 2.4 |
| | SuperLoss | 59.8 ± 0.7 | 56.6 ± 0.5 | 54.3 ± 0.3 | 42.7 ± 0.4 |
| | (τ = | | | | |
| | ExpAvg) | | | | |
| | SuperLoss | 60.6 ± 0.2 | 56.9 ± 0.3 | 54.1 ± 0.4 | 42.8 ± 1.3 |
| | (τ = Avg) | | | | |
| Faster | Baseline | 58.2 ± 0.2 | 50.4 ± 0.8 | 46.8 ± 0.1 | 43.2 ± 0.7 |
| R-CNN | SuperLoss | 57.8 ± 0.2 | 55.4 ± 0.2 | 53.6 ± 0.2 | 50.0 ± 0.3 |
| | (τ = | | | | |
| | ExpAvg) | | | | |
| | SuperLoss | 57.4 ± 0.3 | 52.9 ± 0.3 | 52.3 ± 0.2 | 50.2 ± 0.5 |
| | (τ = Avg) | | | | |

### Evaluation of Superloss for Image Retrieval

SuperLoss was also evaluated on the image retrieval task using the Revisited Oxford and Paris benchmark (described in Radenović F et al., Revisiting Oxford and Paris: Large-scale image retrieval benchmarking, CVPR, 2018). It includes two datasets, Oxford and Paris that include respectively 5,063 and 6,392 high-resolution images. Each dataset includes 70 queries from 11 landmarks. For each query, positive images are labelled as easy or hard positives. Each dataset is evaluated in terms of mean Average-Precision (mAP) using the medium (M) and hard (H) protocols which include respectively considering all positive images or only hard ones (i.e., ignoring easy ones).

For training, the large-scale Landmarks dataset (described in Babenko A. et al., Neural codes for image retrieval, ECCV, 2014) that includes about 200,000 images (divided into 160,000/40,000 for training/validation) gathered semi-automatically using search engines was selected. The fact that a cleaned version of the same dataset (released in Gordo A. et al., Deep image retrieval: Learning global representations for image search, ECCV, 2016) includes about 4 times less images gives a rough idea of the amount of noise the Landmarks dataset includes, and of the subsequent difficulty to leverage this data using standard loss functions.

In order to establish a meaningful comparison the cleaned dataset is also used, which includes 42,000 training and 6,000 validation images. These datasets are referred to as Landmarks-full and Landmarks-clean. As a retrieval model, ResNet-50 was used with Generalized-Mean (GeM) pooling and a contrastive loss. When training on the Landmarks-clean dataset, the default hyper-parameters from Radenović F. et al. for the optimizer and the hard-negative mining procedure (100 epochs, learning rate of 10⁻⁶ with exponential decay of exp(−1/100), 2000 queries per epoch and 20K negative pool size) provide suitable results. In contrast, they lead to poor performance when training on the Landmarks-full dataset. The hyper-parameters for the baseline on the validation set of the Landmarks-full dataset were therefore retuned and it was found that reducing the hard negative mining hyper-parameters may be important (200 queries and 500 negative pool size). In all cases, the SuperLoss was trained with the same settings than the baseline using global averaging for τ. At test time, the testing described in Radenović F et al. was followed, using multiple scales and descriptor whitening.

The mean Average Precision (mAP) for different training sets and losses is reported in Table 9 below. Hard-neg indicates (query size, pool size) used for hard-negative mining. On clean data, the SuperLoss function has a limited impact. However, it provide a larger performance boost on noisy data (Landmarks-full), overall outperforming the baseline trained using clean data. Also included are other results trained and evaluated with identical code at the end of Table 9. The SuperLoss function performs slightly better than ResNet-101+GeM on the RParis dataset despite the deeper backbone and the fact that it is trained on SfM-120k, a clean dataset of comparable size requiring a complex and expensive procedure to collect.

TABLE 9

| | | | Hard- | ROxf | ROxf | RPar | RPar | |
|---|---|---|---|---|---|---|---|---|
| Network + pooling | Training Set | Loss | neg | (M) | (H) | (M) | (H) | Avg |
| ResNet50 + GeM | Landmarks- | Contrastive | 2K, 20K | 61.1 | 33.3 | 77.2 | 57.2 | 57.2 |
| | clean | | | | | | | |
| | | SuperLoss | 2K, 20K | 61.3 | 33.3 | 77.0 | 57.0 | 57.2 |
| | Landmarks- | Contrastive | 2K, 20K | 41.9 | 17.5 | 65.0 | 39.4 | 41.0 |
| | full | | | | | | | |
| | | Contrastive | 200, 500 | 54.4 | 28.7 | 72.6 | 50.2 | 51.4 |
| | | SuperLoss | 200, 500 | 62.7 | 38.1 | 77.0 | 56.5 | 58.6 |
| ResNet-101 + GeM | SfM-120k | Contrastive | 2K, 20K | 65.4 | 40.1 | 76.7 | 55.2 | 59.3 |
| | (clean) | | | | | | | |

When training on the Landmarks-clean dataset, the default hyper-parameters from Radenović F. et al. were used for the optimizer and hard-negative mining. Specifically, training was performed for 100 epochs using the Adam optimizer with a learning rate and weight decay both set to 1e-6. The learning rate is exponentially decayed by exp(−1) overall. At each epoch, 2000 tuples are fed to the network in batches of 5 tuples. Each tuple includes 1 query, 1 positive, and 5 negatives (i.e., 1 positive pair and 5 negative pairs, mined from a pool of 20K hard-negative samples).

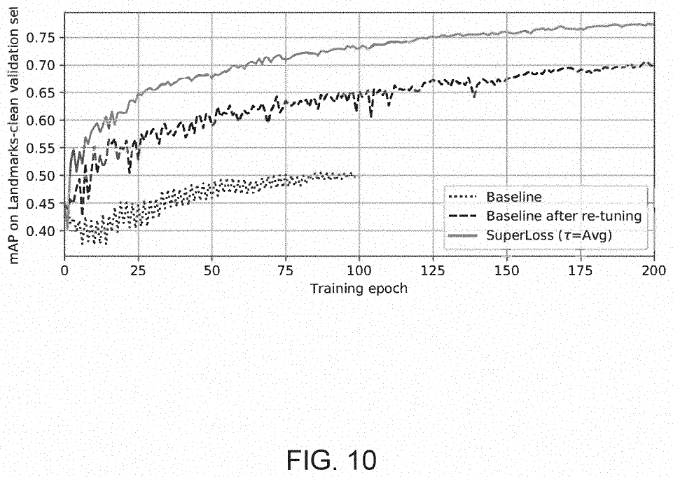

FIG. 10 is a plot of model convergence during training on the noisy Landmarked-full dataset. As can be seen from FIG. 10, when trained on the noisy Landmarks-full dataset using the same settings as described above, the baseline may struggle to converge and its performance may be limited. This may be due to the fact that hard-negative mining may find wrongly labeled negative pairs that prevent the model from properly learning. Reducing the size of the negative pool improves the situation as it makes it less likely that noisy negative images are found. The new learning rate, number of tuples and size of the negative pool are respectively 1e-5, 200 and 500. Since the neural network sees less tuples per epoch (and hence less pairs), training is performed for longer (e.g., 200 epochs instead of 100) with the same overall exponential decay of the learning rate. For the SuperLoss, global averaging is used to compute τ and validate λ=0.05 on the validation set. The convergence of the re-tuned baseline and the SuperLoss are shown in FIG. 10. Even though the baseline improves and converges properly, it is still outperformed by the SuperLoss at all stages of the training.

While some specific embodiments have been described in detail above, it will be apparent to those skilled in the art that various modifications, variations and improvements of the embodiments may be made in the light of the above teachings and within the content of the appended claims without departing from the intended scope of the embodiments. In addition, those areas in which it is believed that those of ordinary skill in the art are familiar have not been described herein in order not to unnecessarily obscure the embodiments described herein. Accordingly, it is to be understood that the embodiments are not to be limited by the specific illustrative embodiments, but only by the scope of the appended claims.

Although the above embodiments have been described in the context of method steps, they also represent a description of a corresponding component, module or feature of a corresponding apparatus or system.

Some or all of the method steps may be implemented by a computer in that they are executed by (or using) a processor, a microprocessor, an electronic circuit or processing circuitry.

The embodiments described above may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

Generally, embodiments can be implemented as a computer program product with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor. In a further embodiment, an apparatus comprises one or more processors and the storage medium mentioned above.

In a further embodiment, an apparatus comprises means, for example processing circuitry such as a processor communicating with a memory, the means being configured to, or adapted to, perform one of the methods described herein.

A further embodiment comprises a computer having installed thereon the computer program or instructions for performing one of the methods described herein.

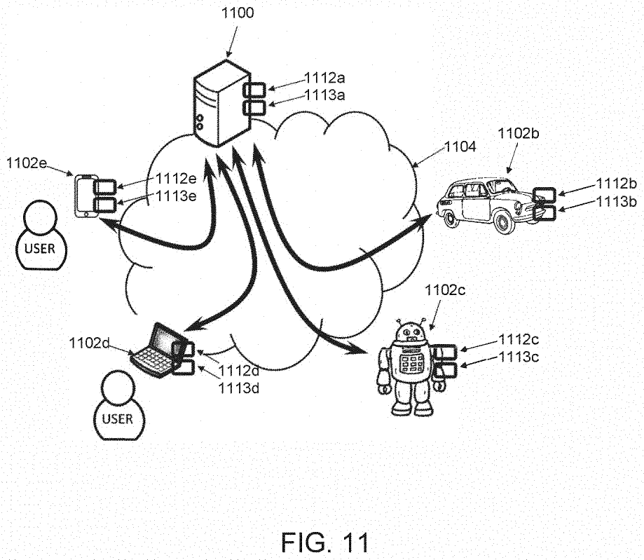

The above-mentioned methods and embodiments may be implemented within an architecture such as illustrated in FIG. 11, which includes server 1100 and one or more computing devices 1102 that communicate over a network 1104 (which may be wireless and/or wired), such as the Internet for data exchange. The server 1100 and the computing devices 1102 each include one or more processors 1112a, 1112b, 1112c, 1112d, and 1112e (“processors 1112”) and memory 1113a, 1113b, 1113c, 1113d, and 1113e (“memory 1113”) such as a hard disk or another suitable type of memory. The devices 1102 may be any type of computing device that communicates with the server 1100, such as vehicles, such as an autonomous vehicle 1102b, robots, such as robots 1102c, computers, such as computer 1102d, cell phones, such as cell phone 1102e, and other types of computing devices.

More precisely in an embodiment, the techniques according to the embodiments described herein may be performed at the server 1100. In other embodiments, the techniques according to the embodiments described herein may be performed at a client device 1102. In yet other embodiments, the techniques described in said embodiments may be performed at a different server or on a plurality of servers in a distributed manner.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer-implemented method for training a neural network to perform a data processing task, comprising:
for each data sample of a set of labeled data samples:
by a first loss function for the data processing task, computing a first loss for that data sample; and
by a second loss function, automatically computing a weight value for the data sample based on the first loss, the weight value indicative of a reliability of a label of the data sample predicted by the neural network for the data sample and dictating the extent to which that data sample impacts training of the neural network; and
training the neural network with the set of labelled data samples according to their respective weight value.

2. The method of claim 1, wherein automatically computing the weight value for the data sample includes increasing the weight value for the data sample if the first loss is less than a threshold value.

3. The method of claim 2, wherein automatically computing the weight value for the data sample includes decreasing the weight value for the data sample if the first loss is greater than the threshold value.

4. The method of claim 2, further comprising computing the threshold value based on a running average of the first loss.

5. The method of claim 2, further comprising computing the threshold value based on an exponential running average of the first loss and using a smoothing parameter.

6. The method of claim 2, wherein the threshold value is a fixed predetermined value.

7. The method of claim 1, wherein automatically computing the weight value includes, by the second loss function, automatically computing the weight value further based on a regularization hyperparameter and a threshold value.

8. The method of claim 7, wherein automatically computing the weight value includes, by the second loss function, setting the weight value one of (a) based on and (b) equal to, a minimum one of: [symbol]
−τ; and
λ( [symbol] −τ),
where [symbol] is the first loss, τ is the threshold value, and λ is the regularization hyperparameter that is between 0 and 1.

9. The method of claim 7, wherein automatically computing the weight value includes, by the second loss function, automatically computing the weight value further based on a confidence value of the data sample.

10. The method of claim 9, further comprising computing the confidence value of the data sample based on the first loss.

11. The method of claim 9, wherein computing the confidence value of the data sample includes computing the confidence value based on minimizing the second loss function for the first loss.

12. The method of claim 9, wherein computing the confidence value of the data sample includes computing the confidence value based on
$$\frac{( ℓ - τ )}{λ} ,$$
where [symbol] is the first loss, τ is the threshold value, and λ is the regularization hyperparameter.

13. The method of claim 9 wherein automatically computing the weight value includes, by the second loss function, automatically computing the weight value based on a loss amplifying term given by
σ*( [symbol] −τ),
where σ* is the confidence value, [symbol] is the first loss, and τ is the threshold value.

14. The method of claim 9, wherein automatically computing the weight value includes, by the second loss function, automatically computing the weight value based on a regularization term given by
λ(log σ*)²,
where σ* is the confidence value, λ is the regularization hyperparameter, and log represents the logarithm function.

15. The method of claim 9, wherein automatically computing the weight value includes, by the second loss function, automatically computing the weight value using the equation
$${min}_{σ} ( σ ( ℓ - τ ) + {λ ( log σ )}^{2} ) ,$$
where σ is the confidence value, [symbol] is the first loss, τ is the threshold value, λ is the regularization hyperparameter, and log represents the logarithm function.

16. The method of claim 1 wherein the second loss function is a monotonically increasing concave function.

17. The method of claim 1 wherein the second loss function is a homogeneous function.

18. The neural network of claim 1 trained according to the method of claim 1.

19. A training system, comprising:
one or more processors;
memory including instructions that, when executed by the one or more processors, train a neural network to perform a data processing task by, for each data sample of a set of labeled data samples:
using a first loss function for the data processing task, computing a first loss for that data sample;
using a second loss function, automatically computing a weight value for the data sample based on the first loss, the weight value indicative of a reliability of a label of the data sample predicted by the neural network for the data sample; and
selectively updating a trainable parameter of the neural network based on the weight value.

20. A method for training a neural network to perform a data processing task, the method comprising:
for each data sample of a set of labeled data samples:
by a first loss function for the data processing task, computing a first loss for that data sample; and
by a second loss function, automatically computing a weight value for the data sample based on the first loss, the weight value indicative of a reliability of a label of the data sample predicted by the neural network for the data sample and dictating the extent to which that data sample impacts training of the neural network; and
training the neural network using the set of labelled data samples with impacts defined by their respective weight values.
